(19) United States
(12) Patent Application Publication
(10) Pub. No.: US 2013/0100232 A1
(43) Pub. Date: Apr. 25, 2013

(54) WIRELESS MOBILE VIDEO

(71) Applicant: MUSE GREEN INVESTMENTS LLC, Dover, DE (US)

(72) Inventor: Bao Q. Tran, San Jose, CA (US)

(73) Assignee: MUSE GREEN INVESTMENTS LLC, Dover, DE (US)

(21) Appl. No.: 13/649,075

(22) Filed: Oct. 10, 2012

Related U.S. Application Data
(63) Continuation of application No. 11/323,789, filed on Dec. 30, 2005, now abandoned.

(51) Int. Cl. H04W 88/02; H04N 7/15

(52) U.S. Cl. CPC H04W 88/02; H04N 7/15
USPC 348/14.02; 455/557

(57) ABSTRACT

Systems and methods are disclosed to operate an electronic device having a mobile wireless broadband radio frequency (RF) circuit, a cellular RF circuit, one or more baseband processors connected to the cellular RF circuit, and the mobile wireless broadband RF circuit. The system selects a multimedia stream from one of the mobile wireless broadband RF circuit and cellular RF circuit, and renders the multimedia stream with an application processor.

### CROSS-REFERENCE TO A RELATED APPLICATION

This application is a continuation of U.S. patent application Ser. No. 11/323,789, filed Dec. 30, 2005, the disclosure of which is hereby incorporated by reference herein.

### BACKGROUND

This disclosure relates generally to wireless multimedia streaming.

Today's most pervasive and versatile portable electronic appliances are our mobile cellular telephones (cell phones). These devices have evolved from brick size analog phones to today's wearable digital phones with personal digital assistant (PDA) functionality. In the process, cell phones have become the most pervasive and prominent communications platform. In this role, they also constitute the largest customer base for portable computers. As portable devices flourish, the demand on network service providers for high speed, i.e., broadband, wireless data communication, has steadily grown. The advantage of wireless is that, in addition to enabling access to data anytime and anywhere, the equipment is easier and cheaper to deploy than wired systems.

Many cell phones include functionality for accessing emails and the Internet and for maintaining call lists, or phone book information, to help alleviate the burdens associated with managing contacts and tracking phone numbers. Modern personal digital assistants (PDAs), smart cellular telephones and other handheld computing devices offer Internet connectivity capabilities, as well as a vast array of hardware and software choices. The PDA is a computer that is small enough to be handheld or placed in a pocket, and allows a user to run various applications, including personal information management applications such as address books, daily organizers, etc. These applications make people's lives easier. The front of the PDA typically includes a touch sensitive screen that allows a user to enter and manipulate data. By using a stylus (or another handheld pointer) to interact with a touch-sensitive screen, the user can easily navigate through a host of built-in programs, software, and other applications.

To provide both organizational features and communication features, PDAs with cellular radios have been developed. The integration of cell phones into PDAs potentially has certain drawbacks that make operation of the combined devices less efficient. For example, a PDA having an integrated cell phone has more processing capability than needed, if the cell phone is simply added to the PDA. Further, a PDA having integrated cell phone capability which uses a single processor to run both the cell phone and PDA is subject to invalid, spurious, rogue, or hacker initiated signals if the PDA processor runs user programs and controls the radio functions of the cell phone. U.S. Pat. No. 6,976,217 discloses the use of separate processors, a PDA processor and a baseband processor, in a PDA having an integrated telephone device. The PDA processor runs PDA related programs and a user interface for the telephone device. A link between the PDA processor and baseband processor transfers data and commands from the user interface to a phone control program executing on the baseband processor. The baseband processor is connected to the telephone device, and the phone control program controls operation of the telephone device. The separation of processors reduces vulnerability of the telephone device to hacker or rogue applications that invade, or program crashes that occur, on the PDA processor.

FIG. 1A shows a PDA/phone device called Q RAZR from Motorola, which offers a full QWERTY keyboard, electro-luminescent keys, one-handed navigation thumbwheel and an internal antenna. The device has a large high-resolution display (320×240 pixels, 65K TFT) with a 1.3 mega pixel still/video camera (with photo lighting) onboard, powered by the Windows Mobile 5.0 operating system. The Moto Q provides multimedia support, playing back iMelody, MIDI, MP3, AAC, WAV, WMA, WAX, QCELP audio files, GIF87a, GIF89a, JPEG, WBMP, BMP, PNG photo files and supports H.263, MPEG-4, GSM-AMR, AAC, and WMV video formats. A Mini-SD slot provides for extra storage, and connectivity is taken care of via Bluetooth, IrDA and mini-USB. The device also provides voice-activated dialing, hands-free multi-tasking, speakerphone and built-in support for Microsoft Exchange 2003.

FIG. 1B shows a Palm Treo device running Windows Mobile. Palm also offers the Treo 650 with its own PalmOS operating system (PalmOS 5.4). The Treo 650 also supports POP3 and IMAP email, plus compatibility with Palm's VersaMail system that allows the Treo 650 to talk to Microsoft Exchange servers. The Treo also takes SD cards for memory expansion and supports SDIO memory and supports video playback with RealPlayer and can play all of the major formats used on the Web, including RealPlayer, Windows Media, QuickTime MPEG-4, MP3, as well as secure versions of these formats used by online music stores. RealVideo 10 provides DVD quality video at approximately 1 Megabit per second, and HiDefinition quality video at approximately 5 Megabits per second.

These devices can also provide entertainment through mobile television and radio service providers such as T-Mobile and MobiTV, Inc. T-Mobile initially launched a service in Germany enabling their subscribers to watch television over GPRS to their mobile phones. The service named “n-tv mobile live TV,” offered a live stream of news direct to the handsets that have the RealPlayer installed. MobiTV offered popular TV channels from content providers such as MSNBC, ABC News Now, CNN, Fox News, Fox Sports, ESPN 3GTV, MLB, NBC Mobile, CNBC, CSPAN, The Discovery Channel, TLC, The Weather Channel, and others that deliver cartoons, music videos, comedy, and geographically specific channels. The MobiTV service consists of a downloaded Java™ application that runs on the mobile phone and a network that broadcasts TV content. Up/down arrows or the joystick on the phone are used to change channels. Hitting the # button will open the channel guide and allow the user to input a channel directly by entering the channel number. For example, the user enters “06” for channel 6, followed by the OK button. According to MobiTV, watching 5 minutes of MobiTV is roughly equal to a megabyte of data usage. Ten minutes of MobiTV would then equate to 2 megabytes of data usage. If a user is on the Pay Per Use plan for data usage, the cost associated with watching 5 minutes of MobiTV would equal approximately $10.00. Hence, transmission cost can be significant for watching full length movies, and MobiTV recommends that cellular users subscribe to the unlimited data usage option.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1A and 1B show representative handheld computers.

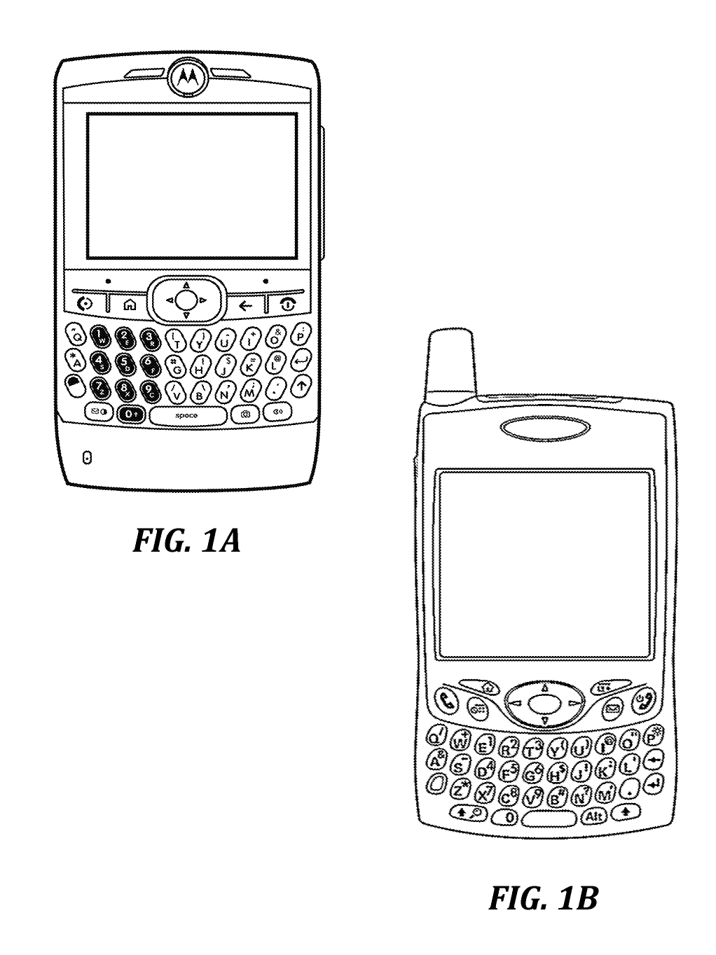

FIG. 2 is a block diagram of one embodiment for a wireless PDA device.

### SUMMARY

Systems and methods are disclosed to operate an electronic device having a mobile wireless broadband radio frequency (RF) circuit, a cellular RF circuit, one or more baseband processors connected to the cellular RF circuit and the mobile wireless broadband RF circuit. The system selects a multimedia stream from one of the mobile wireless broadband RF circuit and cellular RF circuit; and renders the multimedia stream with an application processor.

In one aspect, an electronic device includes a display screen; a mobile wireless broadband radio frequency (RF) circuit; a cellular RF circuit; one or more baseband processors coupled to the cellular RF circuit and the mobile wireless broadband RF circuit to receive a multimedia stream; and an application processor coupled to the display screen and to the one or more baseband processors, the application processor configured to execute a multimedia streaming application.

Implementations of the above aspect may include one or more of the following. The mobile wireless broadband comprises WiMAX or IEEE 802.16e protocol. One of the RF circuit receives H.264 data packets and directs the packets to the multimedia streaming application for processing. The application processor is coupled to a satellite RF circuit to receive satellite transmission such as those from the Iridium satellites or the DirectTV satellites, for example. The application processor is coupled to one of a Bluetooth circuit, an ultra-wide band (UWB) circuit, and an 802.11 circuit, and can provide an Internet hot-spot for Bluetooth, UWB, or 802.11 equipped computers. The application can include a user interface configured to capture user inputs for video viewing operations and an up/down input to select a video channel. The application can accept a channel identifier and request a video stream corresponding to the channel identifier. The application processor can execute applications such as mobile gaming, video on demand, music on demand, conferencing, voice over Internet protocol (VOIP) calling, digital video recording (DVR), and digital music recording, among others. The application processor can display a telephone user interface configured to capture user inputs for telephone related operations and to indicate current telephone operation information on the display screen, and the processor suspends the application when receiving a call and resumes the application when the call ends. A camera output can be provided to the application processor to provide two-way video conferencing. The application processor can aggregate wireless broadband and cellular transmissions together to increase transmission bandwidth. The aggregation can include channel aggregation—for example, multiple cellular channels can be aggregated to provide improved cellular throughput, and multiple WiMAX channels can be aggregated to improve WiMAX bandwidth. In one configuration, multiple cellular channels can be aggregated and multiple WiMAX channels can be aggregated to provide maximum throughput. In another configuration, to save power and cost, the mobile wireless broadband RF circuit provides a receive-only circuit without the transmit portion so that it is optimized to receive broadcast content and a desired channel to be transmitted to the receive-only circuit is communicated using the cellular RF circuit. Alternatively, the application can request a selected channel using the cellular RF circuit and receive the selected channel using the mobile wireless broadband RF circuit. In another implementation, either the mobile wireless broadband RF circuit or the cellular RF circuit can receive IPTV data packets. For High Definition Television (HDTV) content, both the mobile wireless broadband RF circuit and the cellular RF circuit can be configured to receive IPTV data packets. The application can be an Internet-based television application or an Internet-based telephony application in one case. A dedicated hardware MPEG circuit may be provided to process the stream.

In another aspect, a method of operating an electronic device having a mobile wireless broadband radio frequency (RF) circuit, a cellular RF circuit, one or more baseband processors coupled to the cellular RF circuit, and the mobile wireless broadband RF circuit includes selecting a multimedia stream from one of the mobile wireless broadband RF circuit and cellular RF circuit; and rendering the multimedia stream with an application processor.

Implementations of the above method can include one or more of the following. The mobile wireless broadband can be WiMAX, IEEE 802.16e protocol. One of the RF circuit can receive H.264 data packets and the multimedia streaming application processes the H.264 data packets. The method includes receiving satellite transmission. A wireless hot-spot can be provided by routing data received from the mobile wireless broadband RF circuit or the cellular RF circuit to one or more of a Bluetooth circuit, an ultra-wide band (UWB) circuit, and an 802.11 circuit.

In yet another aspect, an electronic device includes an 802.11 transceiver coupled to a wireless mesh having a plurality of wireless radio frequency (RF) circuits to cover a metropolitan area; a cellular RF circuit; one or more baseband processors coupled to the cellular RF circuit and the 802.11 transceiver to receive a multimedia stream; and an application processor coupled to the display screen and to the one or more baseband processors, the application processor configured to execute a multimedia streaming application.

Implementations of the above aspect may include one or more of the following. The RF circuit receives H.264 data packets and the multimedia streaming application processes the H.264 data packets. The wireless mesh can include a plurality of base stations each coupled to a public school broadband network.

Other aspects of the mobile phone system provide for location-based services, act as your wallet for mobile payments, VOIP enabled cell phones, 1 GB or more of storage capacity, satellite radio functionality, a foldable display for their wireless phones, a mapping service for their wireless phone, a location-based service that could locate businesses, a service that could find friends or family members, and/or a location service that would help find alternate traffic routing.

Advantages of the system may include one or more of the following. The system provides major improvements in terms of capabilities of mobile networks. The system supports high performance mobile communications and computing, and offers consumers and enterprises mobile computing and communications anytime, anywhere and enables new revenue generating/productivity enhancement opportunities. Further, in addition to enabling access to data anytime and anywhere, the equipment is easier and cheaper to deploy than wired systems. Besides improving the overall capacity, the system's broadband wireless features create new demand and usage patterns, which will in turn, drive the development and continuous evolution of services and infrastructure.

### DESCRIPTION

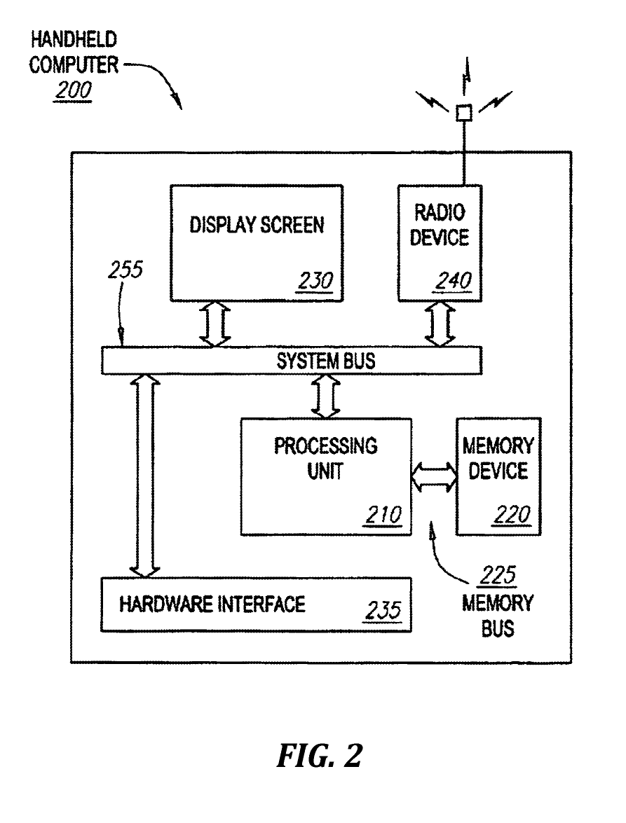

FIG. 2 illustrates a block diagram of selected components of a handheld computer 200 with cell phone capability. The handheld computer 200 includes a processing device 210 for executing applications and an operating system of the computer 200, and a memory device 220 for storing the operating system, data, and the applications. A memory bus 255 is utilized to transfer programs and data from memory 220 to the processing unit 210. A display screen 230 is provided (preferably a touch sensitive screen) for display of Operating System prompts, buttons, icons, application screens, and other data, and for providing user inputs via tapping or touching (or drawing in an area optimized for recognizing handwriting such as a Graffiti™ area) via a stylus or other touch mechanism. A hardware interface 235 connects to physical hard buttons and switches located on a body of the computer 200. The interface 235 provides signals to applications running on the processing unit 210.

A system bus 255 carries data and commands to/from the processing unit 210 from/to other devices within the computer 200. For example, user applications running on the computer 200 send application screens and other data outputs to display screen 230 for display via the system bus 255. User inputs (Graffiti™ area drawing, or tap selection, for example) are detected by the screen 230 and sent to the processing unit 210 via the system bus 255. Connected to the system bus 255 are a plurality of mobile radio devices 240 that can receive cellular, satellite, and WiMAX signals in one representative implementation. In another representative implementation, the radio devices 240 can share certain portions such as baseband processor and have dedicated RF front-end circuits optimized for each of the cellular, satellite, WiMAX, Bluetooth, UWB, and WiFi signals, for example.

Each mobile radio device 240 provides connectivity and can be a land-based wireless voice over IP (VOIP) RF device, a satellite-based wireless RF communication device, a cellular RF device, or a multi-functional RF device having combinations of satellite, VOIP and cellular RF capabilities for network compatibility. For example, the handheld device can receive satellite transmissions, cellular transmissions, and Worldwide Interoperability for Microwave Access (WiMAX) transmissions from a variety of service providers. The same device can also support Bluetooth, Ultra-Wide Band (UWB) and 802.11X wireless local area network (WLAN) such as 802.11a/b/g. The radio device 240 co-exists with overlapping technologies that enable wireless high-speed communications. Wi-Fi, WiMAX, 3G (EV-DO, A, and B; HSDPA, for example) and UWB technologies each are necessary to form the global wireless infrastructure needed to deliver high-speed communications and Internet access worldwide. The Wi-Fi network can be coupled with wireless mesh networking and MIMO enhancements within 802.11n in one embodiment.

WiMAX is a standards-based broadband wireless access technology for enabling the last-mile delivery of information that provides fixed, nomadic, portable and, eventually, mobile wireless broadband connectivity without the need for direct line-of-sight connection between a base station and a subscriber station. In a typical cell radius deployment of 3 to 10 Km, WiMAX systems can support capacity of up to 40 Mbps per channel, for fixed and portable access applications. WiMAX systems operate in licensed and license-exempt bands between 2-6 GHz RF spectrum, for example between 3.3 to 3.8 GHz and 5.7 to 5.8 GHz bands. These profiles cover both TDD and FDD systems. Other system profiles can address the 5.8 GHz license-exempt band, and the 2.5 and 3.5 GHz licensed bands.

One embodiment conforms to the IEEE 802.16e, the mobile Wireless Metropolitan Area Networks (WirelessMAN) standard that will facilitate the global development of mobile broadband wireless access (BWA) systems. The 802.16e system supports a combined fixed and mobile BWA supporting subscriber stations moving at vehicular speeds in licensed bands under 6 GHz.

Meshes of WiFi or WiMAX units can be combined to provide a metropolitan area network as well as extending into a national area network. The WiFi or WiMAX Mesh

Network topology is a semi-mobile system because the connectivity position among the nodes may vary with time due to node departures, new node arrivals, and roaming nodes. A node can send and receive messages so wireless data will find its way to its destination by passing through intermediate nodes with reliable communication links. Thus data must “hop” through neighboring devices to reach its final destination. This multi-hopping capability is designed to create a robust meshed network that automatically routes congestion and line-of-sight obstacles, while improving throughput as subscriber density increases. In mobile communications, this method of multi-hopping is defined as a wireless ad-hoc network.

Ad-hoc networks are defined as networks formed by users or devices wishing to communicate, without the necessity or existence of any infrastructure previously established between the potential network members. Ad-hoc communication can take place in different scenarios and is independent of any specific device, wireless transmission technology, network or protocol. Ad-hoc networks can significantly vary in size depending on application—the networks can contain 2 nodes or thousands of nodes exchanging data. Moreover, nodes are free to enter or leave the network at any time.

Various routing protocols can be used. For example, the Temporally-Ordered Routing Algorithm (TORA) network routing protocol supports a network as a collection of routers (equipped with wireless receiver/transmitters) that are free to move about arbitrarily. The status of the communication links between the routers, at any given time, is a function of their positions, transmission power levels, antenna patterns, channel interference levels, etc. The mobility of the routers and the variability of other connectivity factors result in a network with a potentially rapid and unpredictably changing topology. Congested links are also an expected characteristic of such a network as wireless links inherently have significantly lower capacity than hardwired links and are therefore more prone to congestion. Another protocol is the Ad hoc On Demand Distance Vector (AODV) routing protocol. AODV is capable of both unicast and multicast routing. It is an on demand algorithm, meaning it builds routes between nodes only as desired by source nodes. It maintains these routes as long as they are needed by the sources. Additionally, AODV forms trees that connect multicast group members. The trees are composed of the group members and the nodes needed to connect the members. AODV uses sequence numbers to ensure the freshness of routes. It is loop-free, self-starting, and scales to large numbers of mobile nodes. Other routing protocols can be used. Also, in addition to WiMAX, Bluetooth, IEEE 802.11 and Ultra Wide Broadband (UWB) can also be used in ad-hoc networks.

The wireless mesh can have a plurality of base stations each coupled to a public school broadband network. In this system, each base station is connected to the school's broadband network and communicates with receivers that intercommunicate as a mesh network. The public school system is often regulated by local regulation to a specific population density to improve student performance. For example, in smaller schools (high schools with fewer than 500 students), high academic achievement was achieved, with more students participating in extracurricular activities, having more positive self-images, showing greater personal responsibility, and being more sensitive to the needs of other students. When a network of school base stations is combined with a mesh network provided by the residents living near the school neighborhood, the result is an automatic load-balanced network that expands (or contracts) according to the population density. Such a network can use inexpensive, low power WiFi as the networking hardware. Alternatively, the base station can use WiMAX to provide more bandwidth. The school based approach allows a whole city to be blanketed with wireless signals by providing each school with a wireless base station that is connected to the school's Internet pipe. When all the schools within a district are equipped with the base stations and the mesh network, the entire city can have wireless access using relatively inexpensive WiFi wireless networking devices.

Additionally, in one implementation, a Digital Video Recorder (DVR) application can record multiple programs at once. In another embodiment, the application can process DTCP-IP (Digital Transmission Content Protection over IP) content from providers such as Starz™ and MovieLink™ over the Net.

In another embodiment, the application software allows the user to view Internet Protocol Television (IPTV) over the air. Wireless IPTV allows a digital television service to be delivered to subscribing consumers using the Internet Protocol over a wireless broadband connection. Advantages of IPTV include two-way capability lacked by traditional TV distribution technologies, as well as point-to-point distribution allowing each viewer to view individual broadcasts. This enables stream control (pause, wind/rewind, etc.) and a free selection of programming much like its narrowband cousin, the Web. The wireless service is often provided in conjunction with Video on Demand and may also include Internet services such as Web access and VOIP telephony, and data access (Broadband Wireless Triple Play). A set-top box application software running on the processor 210, and through cellular or wireless broadband internet access, can receive IPTV video streamed to the handheld device.

IPTV covers both live TV (multicasting) as well as stored video (Video on Demand VOD). Video content can be MPEG protocol. In one embodiment, MPEG2TS is delivered via IP Multicast. In another IPTV embodiment, the underlying protocols used for IPTV are IGMP version 2 for channel change signaling for live TV and RTSP for Video on Demand. In yet another embodiment, video is streamed using the H.264 protocol in lieu of the MPEG-2 protocol. H.264, or MPEG-4 Part 10, is a digital video codec standard, which is noted for achieving very high data compression. It was written by the ITU-T Video Coding Experts Group (VCEG) together with the ISO/IEC Moving Picture Experts Group (MPEG) as the product of a collective partnership effort known as the Joint Video Team (JVT). The ITU-T H.264 standard and the ISO/IEC MPEG-4 Part 10 standard (formally, ISO/IEC 14496-10) are technically identical, and the technology is also known as AVC, for Advanced Video Coding. H.264 is a name related to the ITU-T line of H.26x video standards, while AVC relates to the ISO/IEC MPEG side of the partnership project that completed the work on the standard, after earlier development done in the ITU-T as a project called H.26L. It is usual to refer to the standard as H.264/AVC (or AVC/H.264 or H.264/MPEG-4 AVC or MPEG-4/H.264 AVC) to emphasize the common heritage. H.264/AVC/MPEG-4 Part 10 contains features that allow it to compress video much more effectively than older standards and to provide more flexibility for application to a wide variety of network environments. H.264 can often perform radically better than MPEG-2 video—typically obtaining the same quality at half of the bit rate or less. Similar to MPEG-2, H.264/AVC requires encoding and decoding technology to prepare the video signal for transmission, and then on the screen 230 or substitute screens (STB and TV/monitor, or PC). H.264/AVC can use transport technologies compatible with MPEG-2, simplifying an upgrade from MPEG-2 to H.264/AVC, while enabling transport over TCP/IP and wireless. H.264/AVC does not require the expensive, often proprietary, encoding and decoding hardware that MPEG-2 depends on, making it faster and easier to deploy H.264/AVC solutions using standards-based processing systems, servers, and STBs. This also allows service providers to deliver content to devices for which MPEG-2 cannot be used, such as PDAs and digital cell phones.

The H.264/AVC encoder system in the main office turns the raw video signals received from content providers into H.264/AVC video streams. The streams can be captured and stored on a video server at the headend, or sent to a video server at a regional or central office (CO), for video-on-demand services. The video data can also be sent as live programming over the network. Standard networking and switching equipment routes the video stream, encapsulating the stream in standard network transport protocols, such as ATM. A special part of H.264/AVC, called the Network

Abstraction Layer (NAL), enables encapsulation of the stream for transmission over a TCP/IP network, such as a WiMAX Internet access services network. When the video data reaches the handheld device through a WiMAX transceiver, the application software decodes the data using a plug-in for the client's video player (RealPlayer and Windows Media Player, among others).

In addition to the operating system and user selected applications, another application, a VOIP phone application, executes on the processing unit 210. Phone calls from the Internet directed toward the mobile radio device 240 are detected by the mobile radio device 240 and sent, in the form of an incoming call notification, to the phone device (executing on the processing unit 210). The phone device processes the incoming call notification by notifying the user by an audio output such as ringing. The user can answer the incoming call by tapping on a phone icon, or pressing a hard button designated or preprogrammed for answering a call. Outgoing calls are placed by a user by entering digits of the number to be dialed and pressing a call icon, for example. The dialed digits are sent to the mobile radio device 240 along with instructions needed to configure the mobile radio device 240 for an outgoing call using either the cellular RF circuit or the wireless broadband RF circuit. If the call is occurring while the user is running another application such as video viewing, the other application is suspended until the call is completed. Alternatively, the user can view the video in mute mode while answering or making the phone call.

While various embodiments of the present disclosure have been described above, it should be understood that they have been presented by way of example only, and not in limitation. For instance, although examples have been described involving WiMAX, WiFi, Bluetooth, WLAN, and UWB communications, other short-range and longer-range communications technologies are within the scope of the present disclosure.

Accordingly, it will be apparent to persons skilled in the relevant art that various changes in form and detail can be made therein without departing from the spirit and scope of the claimed subject matter. Thus, the breadth and scope of the present disclosure should not be limited by any of the above-described representative embodiments, but should be defined in accordance with the following claims and their equivalents.

1. An electronic device, comprising:
a display screen;
a mobile wireless broadband radio frequency (RF) circuit;
a cellular RF circuit;
one or more baseband processors coupled to the cellular RF circuit and the mobile wireless broadband RF circuit, and configured to receive a media stream; and
an application processor coupled to the display screen and to the one or more baseband processors, the application processor configured to execute a media application, wherein the application processor is configured to simultaneously aggregate wireless broadband and cellular channels together to increase transmission bandwidth.

2. The device of claim 1, wherein the mobile wireless broadband comprises an IEEE 802.16e protocol.

3. The device of claim 1, wherein one of the RF circuit receives H.264 data packets and the media application processes the H.264 data packets.

4. The device of claim 1, wherein the application processor is coupled to a satellite RF circuit to receive satellite transmission.

5. The device of claim 1, wherein the application processor is coupled to one of a Bluetooth circuit, an ultra-wide band (UWB) circuit, and an 802.11 circuit.

6. The device of claim 1, wherein the media application is configured to accept a channel identifier and requests a video stream corresponding to the channel identifier.

7. The device of claim 1, wherein the application processor is configured to execute an application including one or more of a game, a video on demand application, a music on demand application, a conferencing application, a voice over Internet protocol (VOIP) application, a digital video recorder (DVR), and a digital music recorder (DMR).

8. The device of claim 1, wherein the application processor is configured to display a telephone user interface configured to capture user inputs for telephone related operations and to indicate current telephone operations information on the display screen and wherein the application processor is configured to suspend the media application when receiving a call and to resume the multimedia streaming application when the call ends.

9. The device of claim 1, comprising a camera coupled to the application processor configured to provide two-way video conferencing.

10. The device of claim 1, wherein the mobile wireless broadband RF circuit comprises a receive-only circuit to receive broadcasted content and wherein the application processor is configured to request a selected channel over the cellular RF circuit.

11. The device of claim 1, wherein the application processor is configured to request a selected channel using the cellular RF circuit and receives the selected channel using the mobile wireless broadband RF circuit.

12. The device of claim 1, wherein one of the mobile wireless broadband RF circuit and the cellular RF circuit is configured to receive IPTV data packets.

13. The device of claim 1, wherein both the mobile wireless broadband RF circuit and the cellular RF circuit are configured to receive IPTV data packets.

14. The device of claim 1, wherein the media application comprises one of an Internet-based television application and an Internet-based telephony application.

15. The device of claim 1, comprising a hardware MPEG circuit configured to process the media stream.

16. An electronic device, comprising:
a display screen;
a mobile wireless broadband radio frequency (RF) circuit;
a cellular RF circuit;
one or more baseband processors coupled to the cellular RF circuit and the mobile wireless broadband RF circuit, and configured to receive a data stream; and
an application processor coupled to the display screen and to the one or more baseband processors, the application processor configured to execute a media application, wherein the application processor is configured to provide a broadband wireless access point.

17. The electronic device of claim 16, wherein the application processor is coupled to one of a Bluetooth circuit, an ultra-wide band (UWB) circuit, and an 802.11 circuit.

18. The electronic device of claim 16, wherein the application processor is configured to route data received from the mobile wireless broadband RF circuit or the cellular RF circuit to one or more of a Bluetooth circuit, an ultra-wide band (UWB) circuit, and an 802.11 circuit.
